(19) United States
(12) Patent Application Publication
(10) Pub. No.: US 2025/0371728 A1
(43) Pub. Date: Dec. 4, 2025

(54) Human-body-aware visual SLAM in metric scale

(71) Applicant: Adobe Inc., San Jose, CA (US)

(72) Inventors: Chun-hao Huang, London (GB); Yizhou Zhao, Pittsburgh, PA (US); Yangtuanfeng Wang, London (GB); Jimei Yang, Mountain View, CA (US); Duygu Ceylan Aksit, London (GB)

(73) Assignee: Adobe Inc., San Jose, CA (US)

(21) Appl. No.: 18/679,225

(22) Filed: May 30, 2024

(51) Int. Cl. G06T 7/579; G06T 7/215; G06T 7/246; G06T 17/20

(52) U.S. Cl. CPC G06T 7/579; G06T 7/215; G06T 7/251; G06T 17/20; G06T 2207/10016; G06T 2207/10024; G06T 2207/10028; G06T 2207/20081; G06T 2207/30196; G06T 2207/30241

(57) ABSTRACT

In implementation of techniques for scene reconstruction from digital video of moving humans, a computing device implements a scene reconstruction system to receive a digital video depicting a scene including a human and an object. The scene reconstruction system then determines a depth of the human and a depth of the object in the digital video and generates a human mesh modeled from the human in the digital video. Using a machine learning model, the scene reconstruction system determines a size of the object by comparing the depth of the human, the depth of the object, and an estimated dimension of the human mesh. The scene reconstruction system then generates a scene reconstruction including the human mesh and a three-dimensional representation of the object based on the size of the object.

### BACKGROUND

In computer graphics, a scene reconstruction is a translation of a digital image or a digital video depicting a scene into a different format for computer analysis. For example, the scene reconstruction involves a three-dimensional model of the scene, where positions and properties of objects depicted in the scene are described in terms of their coordinates, shapes, textures, and materials. The objects in the scene are represented by their shapes using mathematical primitives including polygons or curves. Surface properties of the objects are also represented in the scene reconstruction, illustrating light reflection, color, and surface texture of the objects. Scene reconstructions are used for a variety of applications, including animation, gaming, and architectural rendering. However, techniques involving generating scene reconstructions involve visual inaccuracies and computational inefficiencies in real world scenarios.

### SUMMARY

Techniques and systems for scene reconstruction from digital video of moving humans are described. In an example, a scene reconstruction system receives a digital video depicting a scene including a human and an object.

The scene reconstruction system determines a depth of the human and a depth of the object in the digital video. The scene reconstruction system also generates a human mesh modeled from the human in the digital video by predicting per-frame segmentation masks for the human. For instance, the human mesh tracks movement of the human in the scene.

Using a machine learning model, the scene reconstruction system determines a size of the object by comparing the depth of the human, the depth of the object, and an estimated dimension of the human mesh. In some examples, the machine learning model is a simultaneous localization and mapping (SLAM) model.

Based on the size of the object, the scene reconstruction system generates a scene reconstruction including the human mesh and a three-dimensional (3D) representation of the object. The scene reconstruction includes scene point clouds indicating 3D features of the object. In some examples, a viewpoint of the scene changes, and the scene reconstruction system determines a camera trajectory corresponding to the viewpoint of the scene based on a determined position of the object relative to the human mesh in the scene reconstruction.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for scene reconstruction from digital video of moving humans as described herein.

FIG. 2 depicts a system in an example implementation showing operation of a scene reconstruction module for scene reconstruction from digital video of moving humans.

FIG. 3 depicts an example of receiving an input including a digital video.

FIG. 4 depicts an example of an architecture including a simultaneous localization and mapping (SLAM) model for scene reconstruction from digital video of moving humans.

FIG. 5 depicts an example of determining a depth of the human and a depth of the object in the digital video.

FIG. 6 depicts an example of determining a size of the object in the digital video.

FIG. 7 depicts a procedure in an example implementation of scene reconstruction from digital video of moving humans.

FIG. 8 depicts a procedure in an additional example implementation of scene reconstruction from digital video of moving humans.

FIG. 9 depicts a procedure in an additional example implementation of scene reconstruction from digital video of moving humans.

FIG. 10 illustrates an example system including various components of an example device that can be implemented as any type of computing device as described and/or utilized with reference to FIGS. 1-9 to implement embodiments of the techniques described herein.

### DETAILED DESCRIPTION

### Overview

A scene reconstruction is a three-dimensional (3D) representation of a scene depicted in a digital video. The digital video, for instance, is a series of video frames depicting objects from different angles. By analyzing the video frames to extract information about positions, movements, and structure of the objects, the scene reconstruction is generated to represent the objects in a 3D environment. Scene reconstructions are used to create realistic virtual environments for virtual reality, including 3D renderings of humans, animals, buildings, or other objects. Scene reconstructions also have applications in animation, robotics, sports analysis, structural inspection, or other applications involving generating 3D models of objects depicted in digital video.

Generating scene reconstructions from a digital video that features changing camera angles or moving humans, however, is challenging because the digital video does not have a consistent coordinate plane. Conventional reconstruction techniques attempt to solve this challenge by generating scene reconstructions by analyzing a digital video one scene at a time. This results in scene reconstructions with objects that are inaccurate in scale compared to humans or other objects in the scene. For instance, objects depicted in the conventional scene reconstructions are too large, too small, or mis-proportioned in relation to other objects. Because conventional scene reconstruction applications are inaccurate in scale, the conventional scene reconstruction techniques are also incapable of generating indications of camera trajectories for the scene.

Techniques and systems are described for generating scene reconstructions from digital video that overcome these limitations. A scene reconstruction system begins in this example by receiving an input including a digital video that depicts a human and an object. Examples of the object include a structure, landscaping, a vehicle, or other object in a foreground or a background of the scene of the digital video. The human, for instance, moves in the digital video relative to the object. In some examples, the digital video is captured from multiple camera trajectories by a moving camera, meaning the digital video depicts different angles of the human and the object in different frames of the digital video.

The scene reconstruction system generates a depth map indicating depths of the human and the object in the digital video using a pretrained monocular depth model. The depth map, for instance, indicates a distance between the human or the object and the camera that captured the digital video. The scene reconstruction system also generates a human mesh based on the human in the digital video, representing 3D surfaces of the human using connected polygons. Based on average statistical sizes for humans, the scene reconstruction system also estimates a size of the human mesh. Using the size of the human mesh as a reference, the scene reconstruction system then uses a simultaneous localization and mapping (SLAM) model to determine a size of the object in the scene of the digital video by comparing the estimated size of the human mesh to the depths of the human and the object from the depth map.

Based on the size of the object, the scene reconstruction system generates a scene reconstruction that accurately represents both the object and the human as point clouds, indicating 3D features of the object and the human at scale. In some examples, the scene reconstruction system also identifies a camera trajectory relative to the point clouds, indicating an angle at which the digital video was captured, which is used for applying the scene reconstruction to other digital content.

Generating scene reconstructions from digital video in this manner overcomes the disadvantages of conventional scene reconstruction techniques that are limited to generating scene reconstructions by analyzing a digital video one scene at a time. For example, generating a human mesh from the digital video and comparing an estimated size of the human mesh to depths of the human and an object from a depth map results in an accurate prediction of the size of the object. Accordingly, because the scene reconstruction system is based on the size of the object, the scene reconstruction features an accurate scale of the object compared to the human in the scene of the digital video. By comparing the estimated size of the human mesh to the depths of the human and the object, the scene reconstruction system also generates indications of camera trajectories for the scene, which is not possible using conventional scene reconstruction techniques that analyze a digital video one scene at a time.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

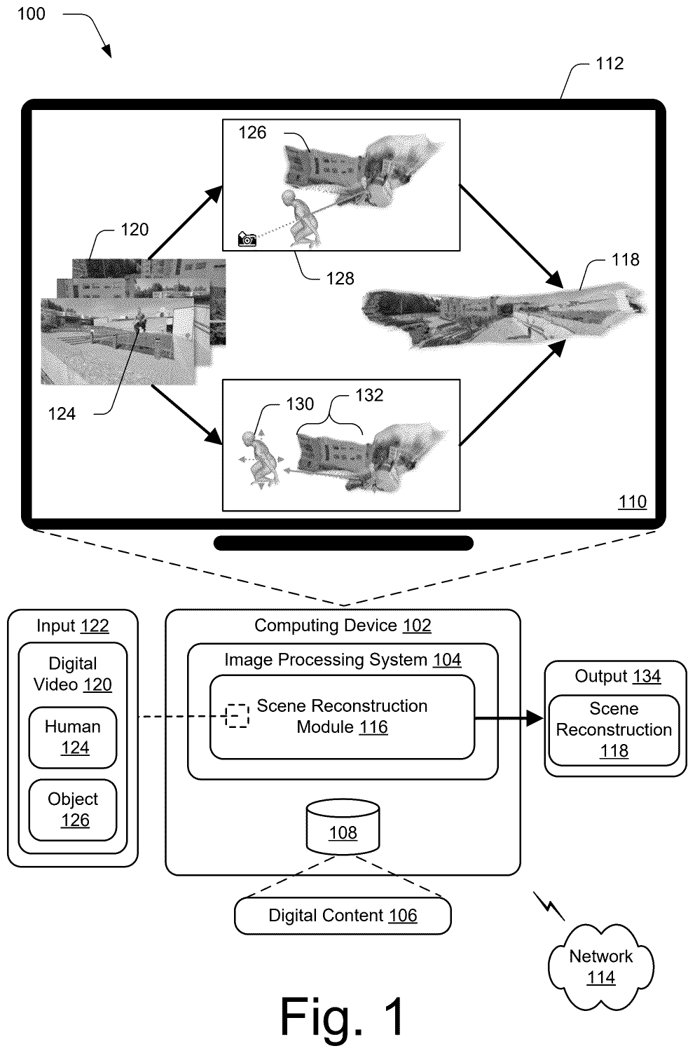

FIG. 1 is an illustration of a digital medium environment 100 in an example implementation that is operable to employ techniques and systems for scene reconstruction from digital video of moving humans described herein. The illustrated digital medium environment 100 includes a computing device 102, which is configurable in a variety of ways.

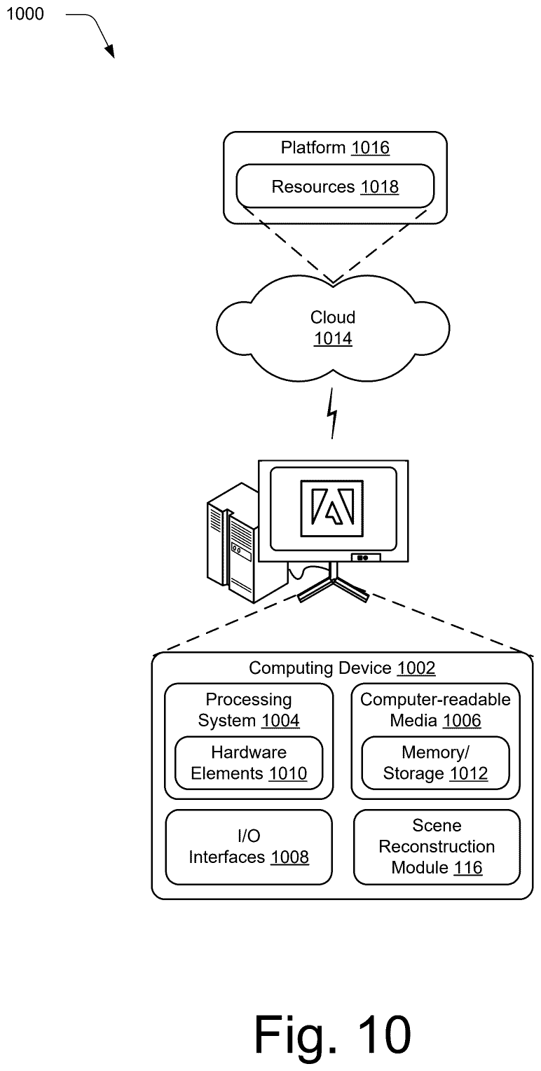

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 10.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a scene reconstruction module 116 which is illustrated as incorporated by the image processing system 104 to process the digital content 106. In some examples, the scene reconstruction module 116 is separate from the image processing system 104 such as in an example in which the scene reconstruction module 116 is available via the network 114.

The scene reconstruction module 116 is configured to generate a scene reconstruction 118 indicating a camera trajectory based on a digital video 120. For example, the scene reconstruction module 116 first receives an input 122 including the digital video 120, which is a red, green blue (RGB) video that depicts a human 124 and an object 126, which is a structure or other object depicted in the scene of the digital video 120. The human 124, for instance, moves in the digital video 120 relative to the object 126 or otherwise interacts with the object 126, which is located in a foreground portion or a background portion of the digital video 120. In some examples, the digital video 120 also features multiple viewpoints. For example, the digital video 120 was captured from multiple camera trajectories, which depict different angles of the human 124 in different scenes of the digital video 120. This results from the camera moving, or the human 124 moving during filming of the digital video 120. In this example, the digital video 120 features a human 124 running and jumping around multiple structures, including a building, which is the object 126.

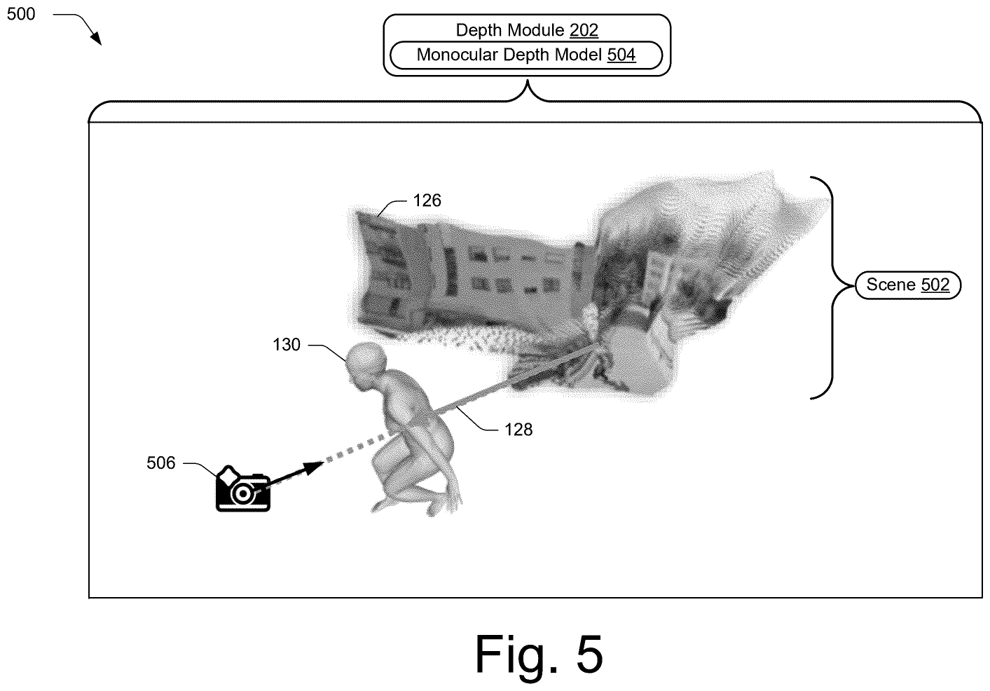

After receiving the input 122, the scene reconstruction module 116 generates a depth map 128 indicating depths of the human 124 and the object 126 in the digital video 120. To generate the depth map 128, the scene reconstruction module 116 uses a pretrained monocular depth model, which estimates a depth value of each pixel in the digital video 120 and is described in further detail with respect to FIG. 5. The depth map 128 indicates a distance between the human 124 or the object 126 and the camera that captured the digital video 120.

The scene reconstruction module 116 also generates a human mesh 130 based on the human 124 in the digital video 120. The human mesh 130 is a three-dimensional (3D) representation of connected polygons forming surfaces of the human 124. To generate the human mesh 130, the scene reconstruction module 116 generates per-frame segmentation masks for the human 124, which indicate which pixels of a frame of the digital video 120 correspond to the human 124, and which pixels of the frame correspond to other portions of the digital video 120, including the object 126, background scenery, the foreground scenery, or other objects. The scene reconstruction module 116 then stitches the per-frame segmentation masks together to form the human mesh 130, which is a 3D mask of the human 124 in some examples. Here, the human mesh 130 depicts 3D surfaces of the man jumping in the digital video 120.

Using a machine learning model, the scene reconstruction module 116 determines an object size 132 of the object 126 in the digital video 120 by comparing the depth map 128 to an estimated dimension of the human mesh 130. Because the depth map 128 indicates the distance between the object 126 and the camera, the machine learning model infers the object size 132 based on the depth map 128 and the estimated dimension of the human mesh 130. The size, for instance, indicates a metric size of the object 126 in numerical measurements. For instance, the scene reconstruction module 116 accurately determines the object size 132 of the building by comparing the depth of the man, the depth of the building, and an estimated size of the man.

The scene reconstruction module 116 then generates an output 134 including the scene reconstruction 118 for display in the user interface 110, including the object 126 positioned in the scene reconstruction 118 based on the determined size of the object 126. The scene reconstruction module 116 accurately reproduces the scene of the digital video 120, including the object 126 positioned in relation to the human 124, including an indication of the one or more camera trajectories. In some examples, the scene reconstruction 118 includes a scene point cloud indicating a position of the human 124 or the object 126 in the digital video 120. For instance, the scene reconstruction 118 includes scene point clouds depicting forms of the man and the building in a virtual 3D environment, in addition to indications of camera trajectories relative to the scene.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

Scene Reconstruction from Digital Video of Moving Humans

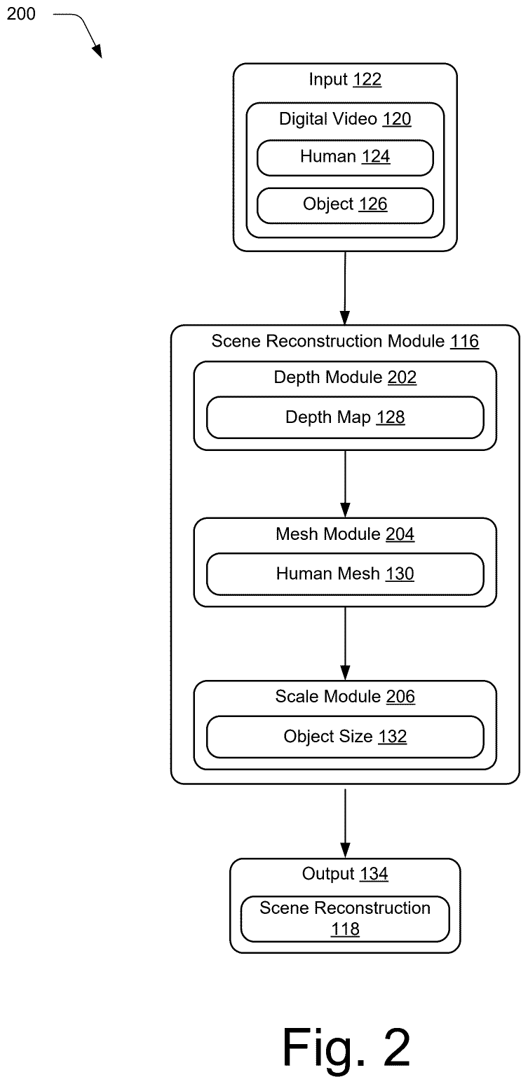

FIG. 2 depicts a system 200 in an example implementation showing operation of the scene reconstruction module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-10.

To begin in this example, a scene reconstruction module 116 receives an input 122 including a digital video 120, which is a red, green, blue (RGB) video depicting a scene captured by a digital video camera from at least one viewpoint. The scene, for instance, includes a human 124 and an object 126. In some examples, the human 124 is moving in the video, including interacting with or moving around the object 126. Additionally or alternatively, the of the digital video changes, resulting from multiple camera angles used while filming the digital video 120.

The scene reconstruction module 116 includes a depth module 202, which generates a depth map 128 indicating depths of the human 124 and the object 126 in the digital video 120. The depths indicate a distance from the camera to the object 126 in the digital video 120 in a frame of the digital video 120. To generate the depth map 128, the depth module 202 uses a monocular depth model that assigns a depth value to each pixel of a frame of the digital video 120.

The scene reconstruction module 116 also includes a mesh module 204. The mesh module 204 generates a human mesh 130 modeled from the human 124 in the digital video 120. The human mesh 130 a collection of vertices, edges, and faces that define the shape of the human 124. For example, the human mesh 130 is a triangle mesh or other polygon mesh that represents the human 124 in a three-dimensional (3D) space.

The scene reconstruction module 116 also includes a scale module 206. The scale module 206 uses a machine learning model to estimate or determine an object size 132 of the object 126 by comparing depths of the depth map 128 to an estimated dimension of the human mesh 130. The scale module 206, for instance, estimates one or more dimensions of the human mesh 130 based on a predicted size of the human 124. Then, based on the one or more dimensions of the human mesh 130, the depth of the human 124 and, the depth of the object 126, the machine learning model, which is a simultaneous localization and mapping (SLAM) model in this example, infers the object size 132.

The scene reconstruction module 116 then generates an output 134 including the scene reconstruction 118, which represents the scene of the digital video 120 in a 3D space. The scene reconstruction 118 includes 3D representations of the human 124 and the object 126, which is positioned and scaled based on the object size 132. The scene reconstruction 118 also indicates a camera trajectory corresponding to the viewpoint of the scene based on the depth map 128 and the object size 132. Therefore, based on the object size 132, the scene reconstruction module 116 generates an accurate 3D representation of the scene of the digital video 120.

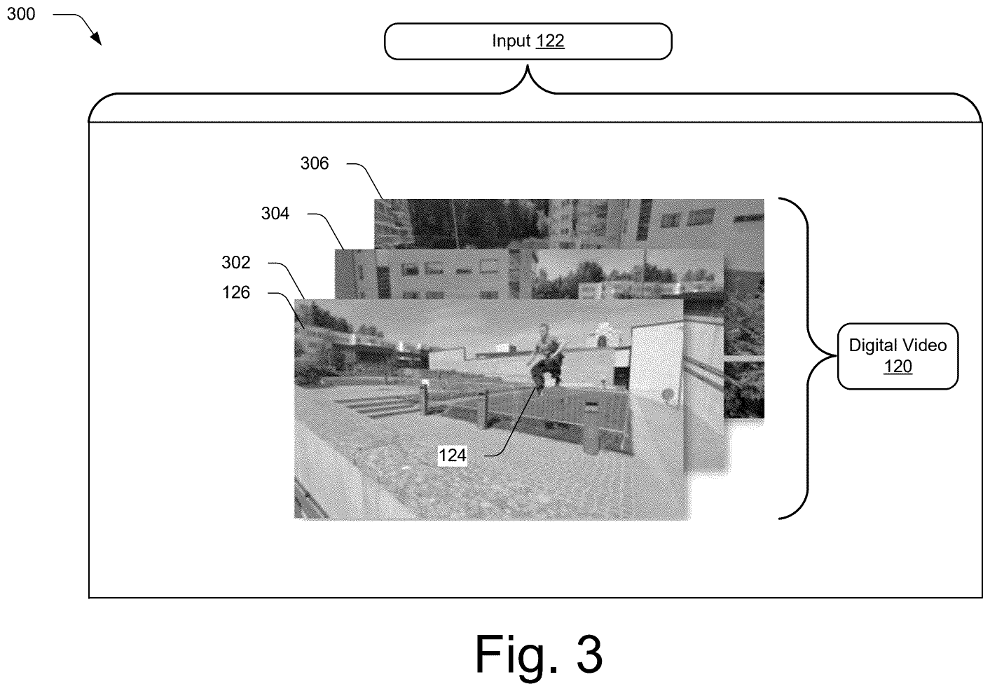

FIGS. 3-6 depict stages of scene reconstruction from digital video of moving humans. In some examples, the stages depicted in these figures are performed in a different order than described below.

FIG. 3 depicts an example 300 of receiving an input including a digital video. As illustrated, the scene reconstruction module 116 receives an input 122 including a digital video 120. For example, the digital video 120 is a red, green, blue (RGB) video

$${\{ {I}_{t} ϵ {R}^{H \times W \times 3} \}}_{t = 1}^{T} ,$$

which is defined by three separate arrays representing intensity of red, green, and blue light at each pixel location.

The digital video 120 is a collection of multiple individual video frames T. For instance, the digital video 120 in this example includes at least a first frame 302, a second frame 304, and a third frame 306, which are captured by a digital camera or other video capture device. In some examples, the digital video 120 is captured from multiple different viewpoints. For instance, a trajectory of the digital camera changes between capture of the first frame 302 and capture of the second frame 304, resulting in the digital video 120 depicting the scene from different angles.

The digital video 120 depicts a scene that includes at least one human 124 (N humans) and object 126. The human 124 moves in the scene and is therefore depicted from multiple angles. The object 126 is a foreground object or background object that the human 124 moves relative to or interacts with. In this example, the scene of the digital video 120 depicts the human 124 jumping over a fence. The object 126 in this example is a building in the background of the scene. Other examples of additional objects include the fence or other buildings surrounding the human 124.

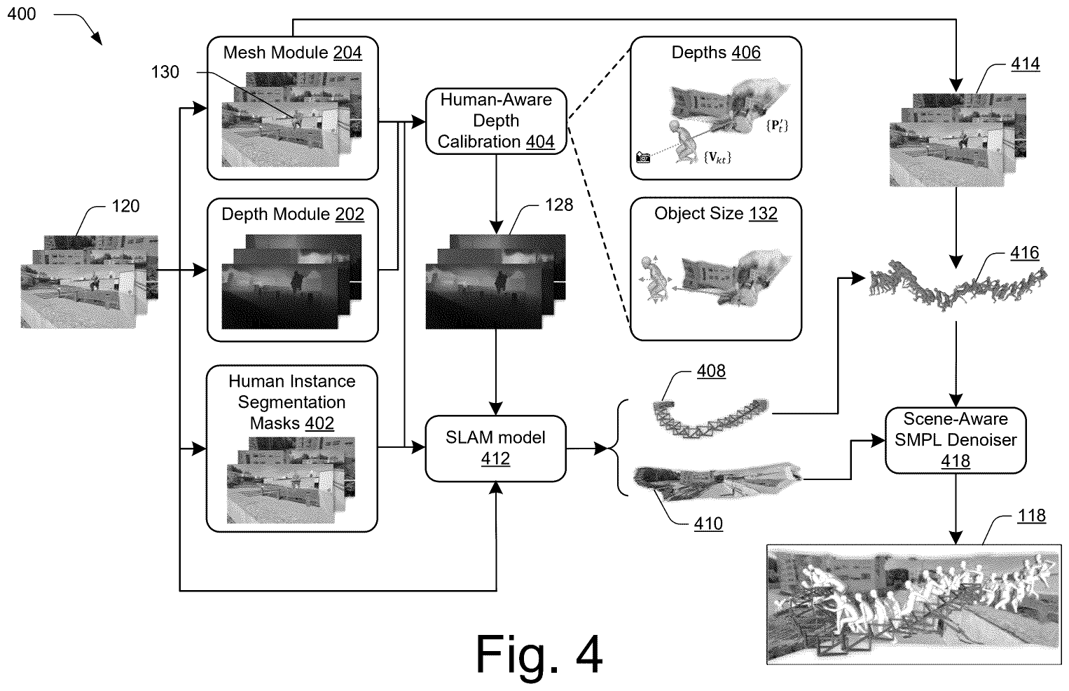

FIG. 4 depicts an example 400 of an architecture including a simultaneous localization and mapping (SLAM) model for scene reconstruction from digital video of moving humans. FIG. 4 is a continuation of the example 300 described with respect to FIG. 3. After the scene reconstruction module 116 receives a digital video 120, the scene reconstruction module 116 leverages the architecture to generate a scene reconstruction 118 of the scene depicted in the digital video 120.

The architecture includes a Human-Aware Metric SLAM phase and a Scene-Aware SMPL Denoising phase. The Human-Aware Metric SLAM phase infers metric-scale camera poses and metric-scale point clouds by exploiting a camera-frame human prior. The Scene-Aware SMPL Denoising phase conditionally denoises world-frame noisy SMPL parameters. The Scene-Aware SMPL Denoising phase initializes the world-frame noisy SMPL parameters by transforming the world-frame noisy SMPL parameters from the camera frame and refining through conditioning on the dynamic point clouds obtained in the Human-Aware Metric SLAM phase. The output of the architecture is a scene reconstruction 118 that reconstructs humans, scene point clouds, and cameras in a common world frame.

Given the digital video 120, for example, a monocular red, green, blue (RGB) video

$${\{ {I}_{t} \}}_{t = 1}^{T} ,$$

the Human-Award Metric SLAM solves a dense bundle adjustment for a set of camera poses

$${\{ {G}_{t} ∈ SE ( 3 ) \}}_{t = 1}^{T}$$

and inverse depths {dₜ∈

$${{ℝ}_{+}^{H \times W} \}}_{t = 1}^{T}$$

for the digital video 120. To update these estimations, the Human-Aware Metric SLAM first computes a dense correspondence field pᵢⱼ∈ [symbol] ^{H×W×2} based on reprojection for a pair of frames (i, j):

$${p}_{i j} = \prod ( {G}_{i j} ∘ {\prod }^{- 1} ( {p}_{i} , \frac{1}{{d}_{i}} ) )$$

where pᵢ∈ [symbol] ^{H×W×2} is a grid of pixel coordinates in frame i, Gᵢⱼ=Gⱼ∘Gᵢ⁻¹ is the relative pose, and Π and Π⁻¹ are the camera projection and inverse projection functions. Then with a learned neural network, the Human-Aware Metric SLAM predicts a revision flow field rᵢⱼ∈ [symbol] ^{H×W×2} and associated confidence map wᵢⱼ∈

$${ℝ}_{+}^{H \times W \times 2}$$

to construct the cost function:

$${E}_{Σ} = {\sum }_{( i , j )} {‖ {p}_{i j}^{*} - \prod ( {G}_{i j} ∘ {\prod }^{- 1} ( {p}_{i} , \frac{1}{{d}_{i}^{′}} ) ) ‖}_{{Σ}_{i j}}^{2}$$

where pᵢⱼ*=rᵢⱼ+pᵢⱼ i is the corrected correspondence, ∥⋅∥_{Σ} is a Mahalanobis distance which weighs the error terms with Σᵢⱼ=diag wᵢⱼ, and G′ and d′ are updated poses and inverse depths. Based on this objective, DROID-SLAM considers an additional term that penalizes a squared distance between the measured and predicted depth if the input is includes an extra sensor depth channel

$${\{ {D}_{t} \}}_{t = 1}^{T} .$$

In this example, each tracked human n in frame t is represented by the SMPL parameters as {Φₙₜ, θₙₜ, βₙₜ, Γₙₜ}, including global orientation Φₙₜ∈ [symbol] ^{3×3}, body pose θₙₜ∈ [symbol] ^{22×3×3}, shape βₙₜ∈ [symbol] ¹⁰, and root translation Γₙₜ∈ [symbol] 3. The parametric SMPL model then uses the SMPL parameters to recover a second timestamp with vertices Vₙₜ∈ [symbol] ^{3×6890} in metric scale: Vₙₜ=SMPL(Φₙₜ, θₙₜ, βₙₜ)+Γₙₜ.

Regarding the Human-aware Metric SLAM phase, to preprocess per-frame depth maps {Dₜ} from a depth module 202 with an off-the-shelf absolute depth estimator and predict per-frame human instance segmentation masks 402 {Mₙₜ} with an image instance segmentation network, ZoeDepth is adapted for video-consistent depth estimation by choosing a per-video metric head from the majority vote of per-frame routers. ZoeDepth is a deep learning model for metric depth estimation from a single image. Because a domain gap persists with inference on new datasets using ZoeDepth, the output is characterized as an up-to-affine depth for further alignment with the metric scale. To aid optimization with human awareness, camera-frame human meshes

$$\{ {V}_{n t}^{c} \}$$

from a mesh module 204 are used to introduce a metric prior.

Calibrating the per-frame depths with human meshes in human-aware depth calibration involves optimizing two parameters using human-aware depth calibration 404, a world scale s and a world offset o, shared across frames of the digital video 120. During optimization, Dₜ is linearly transformed to

$${D}_{t}^{′} = {s D}_{t} + {\prod }^{- 1} ( {p}_{t} , {D}_{t}^{′} ) .$$

o, and the depths 406 are unprojected to camera-frame point clouds

$$\{ {P}_{t}^{c} \}$$

with

$${P}_{t}^{c} = {\prod }^{- 1} ( {p}_{t} , {D}_{t}^{′} ) .$$

A depth term is used to align to pull points on the human point cloud toward their corresponding human mesh vertices along the z-axis:

$${E}_{depth} = \frac{{\sum }_{n , t} {S}_{n t} ⊙ {‖ z ( {V}_{n t}^{c} ) - z ( {P}_{n t}^{c} ) ‖}_{2}^{2}}{{\sum }_{n , t} {‖ {S}_{n t} ‖}_{0}}$$

where

$${S}_{n t} = ρ ( {V}_{n t}^{c} ) ∩ {M}_{n t}$$

is the intersection of the rasterized human mesh mask

$$ρ ( {V}_{n t}^{c} ) ,$$

the instance segmentation mask Mₙₜ, z(⋅) is the rasterized depth, and ∥⋅∥₀ is the 0-norm indicating the number of non-zero pixels on a mask.

Because the recovered human meshes from the mesh module 204 are noisy in depth but still have a stable body dimension, a size term for the object size 132 of the object 126 is adopted to leverage the relative position of mesh vertices:

$${E}_{d x} = \frac{{\sum }_{n , t} {‖ {Δ}_{x} ( {V}_{nt}^{c} , {S}_{n t} ) - {Δ}_{x} ( {P}_{nt}^{c} , {S}_{n t} ) ‖}_{2}^{2}}{N T}$$

$${E}_{d y} = \frac{{\sum }_{n , t} {‖ {Δ}_{y} ( {V}_{nt}^{c} , {S}_{n t} ) - {Δ}_{y} ( {P}_{nt}^{c} , {S}_{n t} ) ‖}_{2}^{2}}{N T}$$

$${E}_{s i z e} = {E}_{d x} + {E}_{d y}$$

where

$${Δ}_{*} ( X , Y ) = ( {max}_{*} - {min}_{*} ) [ {Π}^{- 1} ( Y ⊙ Π ( X ) , z ( X ) ) ]$$

and (max.−min.) denotes the difference between the maximum value and the minimum value on coordinate *. The equation for the calibrated depths with optimization is:

$$( {s}^{m} , {o}^{m} ) = arg {min}_{s , o} ( {E}_{d e p t h} + λ {E}_{s i z e} ) , {D}_{t}^{m} = {s}^{m} {D}_{t} + {o}^{m} ,$$

where λ is a hyperparameter to balance two energy terms with a default value of 1.

While DROID-SLAM supports an RGB-D input mode, where the D channel stands for sensor depth, sensor depths cannot be accessed from “in-the-wild” videos. However, an estimated absolute depth can be utilized as a depth prior. Therefore, the original RGB video and the calibrated depth are combined as pseudoRGB-D inputs

$$\{ {I}_{t} , {D}_{t}^{m} \}$$

to disambiguate depth and scale. Furthermore, the cost function is modified to resolve the dynamic ambiguity by masking out dynamic foregrounds in confidence maps:

$${\sum }_{i j}^{′} = diag {w}_{ij}^{′} = diag ( ( 1 - [ {M}_{i} , {M}_{j} ] ) ⊙ {w}_{i j} )$$

where Mᵢ=∪ₙMₙᵢ and Mⱼ=∪ₙMₙⱼ are the union of human instance masks on their corresponding frame, and [⋅,⋅] is the concatenation operation. As a result, metric-scale camera poses 408

$$\{ {G}_{t}^{m} \}$$

and metric-scale point clouds 410

$$\{ {P}_{t}^{w m} \}$$

are obtained by disambiguating the SLAM model 412 with calibrated metric depths of the depth map 128:

$$\{ {G}_{t}^{m} , {d}_{t}^{m} \} = arg {min}_{\{ {G}_{ij}^{′} , {d}_{i j}^{′} \}} {E}_{{Σ}^{′}} {P}_{t}^{w m} = {G}_{t}^{m} ∘ {Π}^{- 1} ( {p}_{t} , \frac{1}{{d}_{t}^{m}} ) ) .$$

To position humans in the scene recovered by the SLAM model 412, the humans are initialized by transforming estimated camera-frame SMPL parameters 414

$$\{ {Φ}_{n t}^{c} , {θ}_{n t} , {β}_{n t} , {Γ}_{n t}^{c} \}$$

to the world frame with camera-to-world transforms

$$\{ {G}_{t}^{m} = [ {R}_{t} \vert {t}_{t}^{m} ] \}$$

to generate world-frame noisy SMPL parameters 416. Given a pelvis of the human 124 as the center of global orientation Φ:

$${Φ}_{n t}^{w} = {R}_{t} {Φ}_{n t}^{c} , {Γ}_{n t}^{w} = {R}_{t} ( {Γ}_{n t}^{c} + c ) + {t}_{t}^{m} - c ,$$

where c=c(βₙₜ) is the pelvis location in the shape blend body mesh. Note that an extra camera scale is not introduced because the camera poses have already been in the metric scale. The root-relative poses θₙₜ and the shapes βₙₜ stay unchanged as in the camera frame.

Different from conventional techniques that incorporate energy terms in optimization to apply explicit scene by conditioning on implicit scene constraints:

$${z}_{n t , 0}^{S M P L} = F C ( [ {Φ}_{n t , 0}^{w} , {θ}_{n t , 0} , {β}_{n t , 0} , {Γ}_{n t , 0}^{w} ] ) + TPE \\ {\{ {z}_{n t , 1}^{S M P L} \}}_{t = 1}^{T} = 𝒟 ( {\{ {z}_{n t , 0}^{S M P L} \}}_{t = 1}^{T} , ε ( {x}^{s c e n e} ) + TPE )$$

where FC is a shared linear layer, TPE is shared temporal positional embeddings,

$${\{ {z}_{n t , *}^{S M P L} \}}_{t = 1}^{T} ∈ {ℝ}^{T \times D}$$

is the D dimensional latent for human n, and x^{scene}∈ [symbol] ^{L×C} is the C-channel dynamic scene point clouds with a total number of points L. [symbol] and [symbol] refer to the scene encoder and the scene-conditioned denoiser, respectively. C is set to C=7, which is the concatenation of point coordinates

$$\{ {P}_{t}^{w m} \} ,$$

colors {Iₜ}, and estimated human semantic segmentation masks {Mₜ=∪ₙMₙₜ}. The updated dimensional latent is decoded with different prediction head [symbol] _{(⋅)} to regress the residual for each SMPL parameter:

$${Φ}_{n t , 1}^{w} = {𝒫}_{Φ} ( {z}_{n t , 1}^{S M P L} ) {Φ}_{n t , 0}^{w} \\ {θ}_{n t , 1} = {𝒫}_{θ} ( {z}_{n t , 1}^{S M L} ) {θ}_{n t , 0} \\ {β}_{n t , 1} = {𝒫}_{β} ( {z}_{n t , 1}^{S M P} ) + {β}_{n t , 0} \\ {Γ}_{n t , 1}^{w} = {𝒫}_{Γ} ( {z}_{n t , 1}^{S M P L} ) + {Γ}_{n t , 0}^{w}$$

and direct supervision is then applied on

$${\{ {Φ}_{n t}^{w} , {θ}_{n t} , {β}_{n t} , {Γ}_{n t}^{w} \}}_{1} .$$

A scene-aware SMPL denoiser 418 then takes as input the world-frame noisy SMPL parameters 416 and the metric-scale point clouds 410 from the human-aware metric SLAM phase to generate the scene reconstruction 118.

FIG. 5 depicts an example 500 of determining a depth of the human 124 and a depth of the object 126 in the digital video 120. The scene reconstruction module 116 includes a depth module 202 that determines depths of objects in a scene 502 of the digital video the digital video 120, and the scene reconstruction module 116 also includes a mesh module 204 that generates a human mesh 130 for at least one human depicted in the digital video 120.

The depth module 202 generates a depth map 128 indicating depths of the human 124 and the object 126 in the digital video 120. The depths indicate a distance from the camera to the object 126 in the digital video 120 in a frame of the digital video 120. To generate the depth map 128, the depth module 202 uses a monocular depth model 504 that assigns a depth value to each pixel of a frame of the digital video 120. The monocular depth model 504 is a type of deep learning architecture designed to infer a three-dimensional (3D) structure of a scene image from a single input image frame of the digital video 120. When the scene image is input into the model, the scene image first undergoes a process of feature extraction using a convolutional neural network, extracting hierarchical and abstract features from the scene image, including edges, textures, and shapes of the object 126 in the digital video 120. Following the feature extraction, the model predicts the depth map 128 of the scene, which is a two-dimensional representation including pixels that correspond to an estimated distance from the camera to the scene point.

The depth map 128 is generated by the monocular depth model 504 using a variety of possible approaches. The first approach includes directly regressing depth values from the extracted features, resulting in a single-channel depth map. The second approach includes predicting a disparity map, which is then converted to a depth map using camera parameters for stereo images. Training the monocular depth model 504 involves paired datasets of images with corresponding ground truth depth maps, with the monocular depth model 504 learning to minimize differences between its predictions and the true depths using loss functions, including Mean Squared Error. After training, the monocular depth model 504 is then used by the depth module 202 of the scene reconstruction module 116 to estimate depth for new images.

The scene reconstruction module 116 also includes a mesh module 204. The mesh module 204 generates a human mesh 130 modeled from the human 124 in the digital video 120. The human mesh 130 a collection of vertices, edges, and faces that define the shape of the human 124. For example, the human mesh 130 is a triangle mesh or other polygon mesh that represents the human 124 in a 3D space.

To generate the human mesh 130 in some examples, the mesh module 204 uses a combination of pose estimation techniques, including two-dimensional (2D) pose estimation and 3D pose estimation. 2D pose estimation identifies key body joints including shoulders and knees in each video frame of the digital video 120. Subsequently, the estimation progresses to 3D poses, for understanding of the body's 3D position and orientation, computed using known body proportions, camera geometry or deep learning. Depth information from the depth module 202 is also incorporated into the human mesh 130 in some examples.

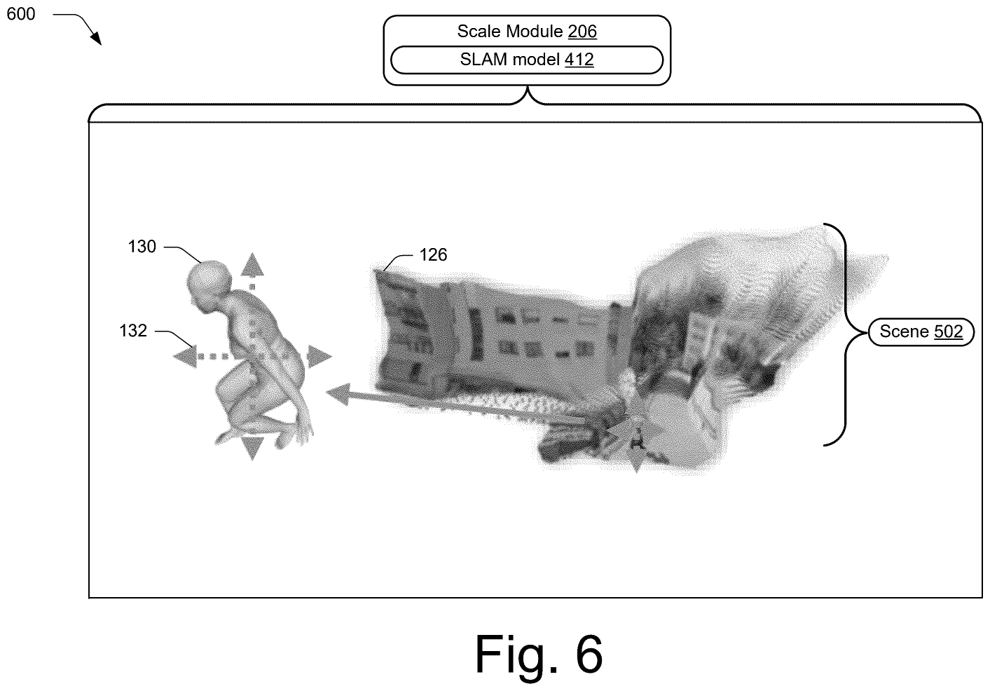

In some examples, the scene reconstruction module 116 determines a camera trajectory 506 based on the depth map 128 and the human mesh 130. The camera trajectory 506, for instance, corresponds to a viewpoint of the scene 502 at a particular frame of the digital video 120. To determine the camera trajectory 506, the scene reconstruction module 116 compares the depth of the human 124, the depth of the object 126, and the human mesh 130. In this way, the scene reconstruction module 116 infers relationships between the human 124 and the object 126 in the scene 502 to determine the camera trajectory 506 for the scene 502. In examples involving changing camera scenes, the scene reconstruction module 116 identifies multiple camera trajectories. Although this example contemplates the camera trajectory 506 determined in conjunction with the depth module 202 and the mesh module 204, in other examples, the camera trajectory 506 is determined by the scale module 206 using the SLAM model 412, described in relation to FIG. 6 below.

FIG. 6 depicts an example 600 of determining a size of the object in the digital video. The scene reconstruction module 116 includes a scale module 206 that leverages a simultaneous localization and mapping (SLAM) model 412 to determine the object size 132 of the object 126 in the digital video 120.

The scale module 206, for instance, receives as input the depth map 128 including depths of the object 126 and the human mesh 130 in the digital video 120, in addition to an estimated dimension of the human mesh 130. The scale module 206 uses the SLAM model 412 to compare the depths of the depth map 128 to the estimated dimension of the human mesh 130. The scale module 206, for instance, estimates one or more dimensions of the human mesh 130 based on a predicted size of the human 124. Then, based on the one or more dimensions of the human mesh 130 with a depth of the human 124 and a depth of the object 126, the SLAM model 412 infers the object size 132 of the object 126 in the scene 502 of the digital video 120. The SLAM model 412, for instance, generates a map of an unknown environment based on the scene 502 by integrating known relationships between the human 124 and the object 126 using SLAM algorithms.

The scene reconstruction module 116 then uses the object size 132 to generate a scene reconstruction 118 of the scene 502 of the digital video 120. The scene reconstruction module 116 accurately reproduces the scene 502 of the digital video 120, including the object 126 positioned in relation to the human 124, including an indication of the one or more camera trajectories. In some examples, the scene reconstruction 118 includes a scene point cloud indicating a position of the human 124 or the object 126 in the digital video 120.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-10.

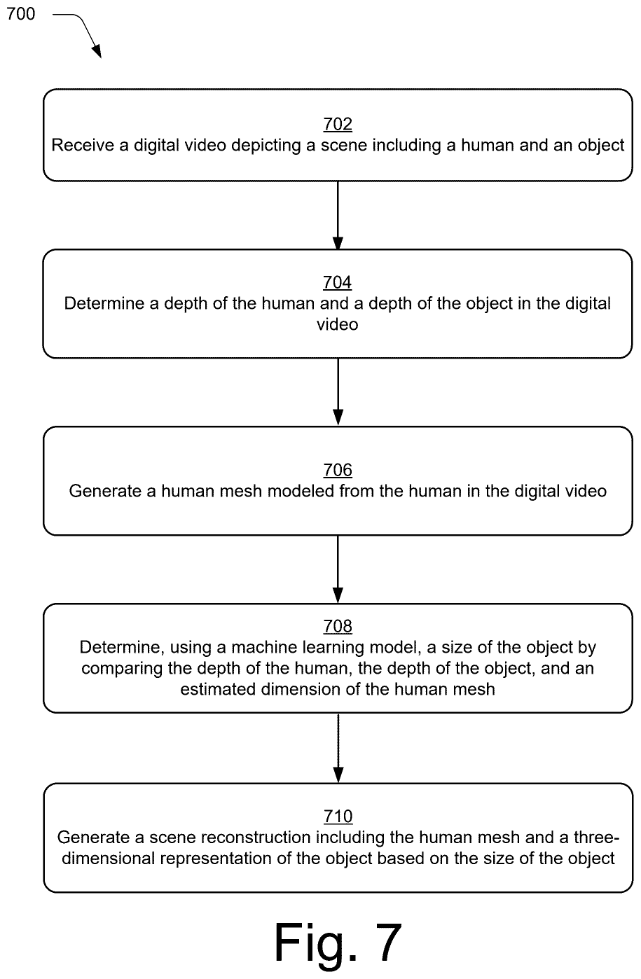

FIG. 7 depicts a procedure 700 in an example implementation of scene reconstruction from digital video of moving humans. At block 702, a digital video 120 depicting a scene including a human 124 and an object 126 is received. For example, the digital video 120 is an RGB video. In some examples, a viewpoint of the scene changes.

At block 704, a depth of the human 124 and a depth of the object 126 in the digital video 120 are determined. For example, the depth of the human 124 and the depth of the object 126 are determined using a monocular depth model.

At block 706, a human mesh 130 modeled from the human 124 in the digital video 120 is generated. In some examples, the human mesh 130 is generated by predicting per-frame segmentation masks for the human 124. For example, the human mesh 130 tracks movement of the human 124 in the scene.

At block 708, a size of the object 126 is determined using a machine learning model by comparing the depth of the human 124, the depth of the object 126, and an estimated dimension of the human mesh 130. For example, the machine learning model is a simultaneous localization and mapping (SLAM) model.

At block 710, a scene reconstruction 118 is generated including the human mesh 130 and a three-dimensional representation of the object 126 based on the size of the object 126. In some examples, the scene reconstruction 118 includes scene point clouds indicating three-dimensional features of the object 126. Some examples further comprise determining a camera trajectory corresponding to the viewpoint of the scene based on a determined position of the object 126 relative to the human mesh 130 in the scene reconstruction 118.

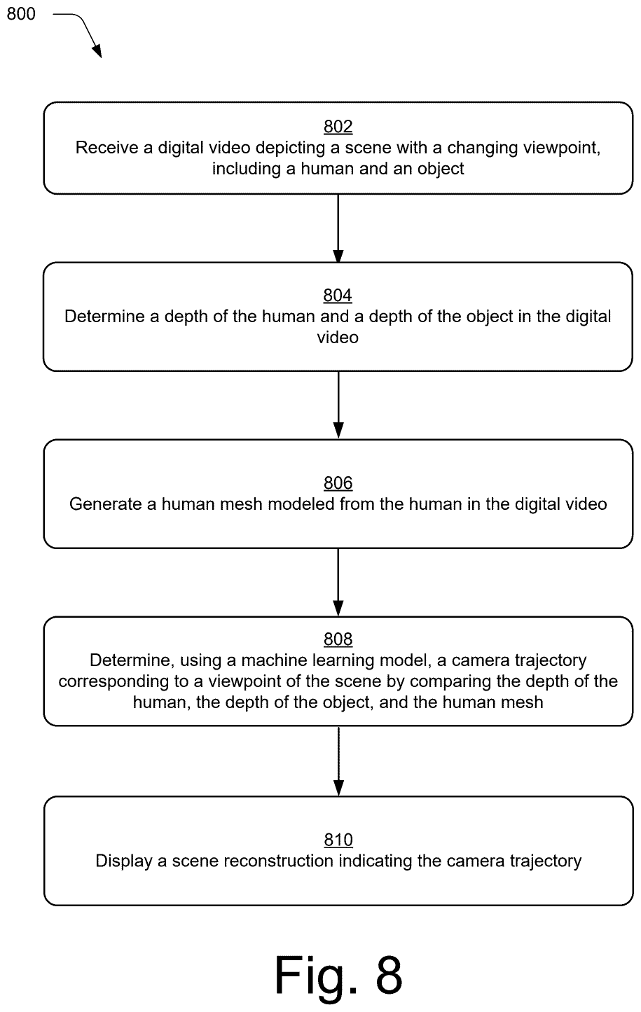

FIG. 8 depicts a procedure 800 in an additional example implementation of scene reconstruction from digital video of moving humans. At block 802, a digital video 120 is received depicting a scene with a changing viewpoint, including a human 124 and an object 126.

At block 804, a depth of the human 124 and a depth of the object 126 in the digital video 120 are determined. For example, the depth of the human 124 and the depth of the object 126 are determined using a monocular depth model.

At block 806, a human mesh 130 is generated that is modeled from the human 124 in the digital video 120. In some examples, the human mesh 130 is generated by predicting per-frame segmentation masks for the human 124. For example, the human mesh 130 tracks movement of the human 124 in the scene.

At block 808, a camera trajectory corresponding to a viewpoint of the scene is determined using a machine learning model by comparing the depth of the human 124, the depth of the object 126, and the human mesh 130. Some examples further comprise determining, using the machine learning model, a size of the object 126 by comparing the depth of the human 124, the depth of the object 126, and an estimated dimension of the human mesh 130. In some examples, the machine learning model is a simultaneous localization and mapping (SLAM) model.

At block 810, a scene reconstruction 118 indicating the camera trajectory is displayed. For example, the scene reconstruction 118 includes scene point clouds indicating three-dimensional features of the object 126.

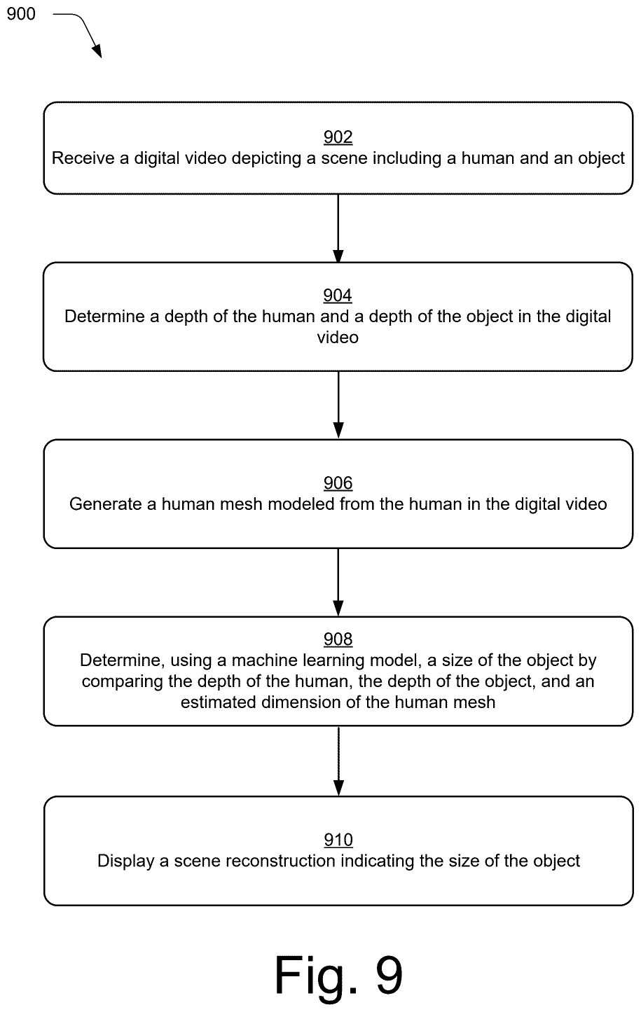

FIG. 9 depicts a procedure 900 in an additional example implementation of scene reconstruction from digital video of moving humans. At block 902, a digital video 120 is received depicting a scene including a human 124 and an object 126.

At block 904, a depth of the human 124 and a depth of the object 126 in the digital video 120 are determined. For example, the depth of the human 124 and the depth of the object 126 are determined using a monocular depth model.

At block 906, a human mesh 130 is generated that is modeled from the human 124 in the digital video 120. In some examples, the human mesh 130 tracks movement of the human 124 in the scene. For example, the human mesh 130 is generated by predicting per-frame segmentation masks for the human 124.

At block 908, a size of the object 126 is determined using a machine learning model by comparing the depth of the human 124, the depth of the object 126, and an estimated dimension of the human mesh 130. In some examples, the machine learning model is a simultaneous localization and mapping (SLAM) model.

At block 910, a scene reconstruction 118 indicating the size of the object 126 is displayed. Some examples further comprise a viewpoint of the scene that changes, and a camera trajectory that is determined corresponding to the viewpoint of the scene based on a determined position of the object 126 relative to the human mesh 130 in the scene reconstruction 118.

### Example System and Device

FIG. 10 illustrates an example system generally at 1000 that includes an example computing device 1002 that is representative of one or more computing systems and/or devices that implement the various techniques described herein. This is illustrated through inclusion of the scene reconstruction module 116. The computing device 1002 is configurable, for example, as a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices and/or processing systems 1004) to implement techniques, modules, and examples described herein.

The techniques described herein are supported by various configurations of the computing device 1002 and are not limited to the specific examples of the techniques described herein. This functionality is also implementable through use of a distributed system, such as over a “cloud” 1114 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized when computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

What is claimed is:

1. A method comprising:
receiving, by a processing device, a digital video depicting a scene including a human and an object;
determining, by the processing device, a depth of the human and a depth of the object in the digital video;
generating, by the processing device, a human mesh modeled from the human in the digital video;
determining, by the processing device using a machine learning model, a size of the object by comparing the depth of the human, the depth of the object, and an estimated dimension of the human mesh; and
generating, by the processing device, a scene reconstruction including the human mesh and a three-dimensional representation of the object based on the size of the object.

2. The method of claim 1, wherein a viewpoint of the scene changes.

3. The method of claim 2, further comprising determining a camera trajectory corresponding to the viewpoint of the scene based on a determined position of the object relative to the human mesh in the scene reconstruction.

4. The method of claim 1, wherein the depth of the human and the depth of the object are determined using a monocular depth model.

5. The method of claim 1, wherein the machine learning model is a simultaneous localization and mapping (SLAM) model.

6. The method of claim 1, wherein the scene reconstruction includes scene point clouds indicating three-dimensional features of the object.

7. The method of claim 1, wherein the human mesh is generated by predicting per-frame segmentation masks for the human.

8. The method of claim 1, wherein the human mesh tracks movement of the human in the scene.

9. The method of claim 1, wherein the digital video is an RGB video.

10. A system comprising:
a memory component; and
a processing device coupled to the memory component, the processing device to perform operations comprising:
receiving a digital video depicting a scene with a changing viewpoint, including a human and an object;
determining a depth of the human and a depth of the object in the digital video;
generating a human mesh modeled from the human in the digital video;
determining, using a machine learning model, a camera trajectory corresponding to a viewpoint of the scene by comparing the depth of the human, the depth of the object, and the human mesh; and
displaying a scene reconstruction indicating the camera trajectory.

11. The system of claim 10, further comprising determining, using the machine learning model, a size of the object by comparing the depth of the human, the depth of the object, and an estimated dimension of the human mesh.

12. The system of claim 10, wherein the depth of the human and the depth of the object are determined using a monocular depth model.

13. The system of claim 10, wherein the machine learning model is a simultaneous localization and mapping (SLAM) model.

14. The system of claim 10, wherein the scene reconstruction includes scene point clouds indicating three-dimensional features of the object.

15. The system of claim 10, wherein the human mesh is generated by predicting per-frame segmentation masks for the human.

16. The system of claim 10, wherein the human mesh tracks movement of the human in the scene.

17. A non-transitory computer-readable storage medium storing executable instructions, which when executed by a processing device, cause the processing device to perform operations comprising:
receiving a digital video depicting a scene including a human and an object;
determining a depth of the human and a depth of the object in the digital video;
generating a human mesh modeled from the human in the digital video;
determining, using a machine learning model, a size of the object by comparing the depth of the human, the depth of the object, and an estimated dimension of the human mesh; and
displaying a scene reconstruction indicating the size of the object.

18. The non-transitory computer-readable storage medium of claim 17, wherein a viewpoint of the scene changes, and further comprising determining a camera trajectory corresponding to the viewpoint of the scene based on a determined position of the object relative to the human mesh in the scene reconstruction.

19. The non-transitory computer-readable storage medium of claim 17, wherein the machine learning model is a simultaneous localization and mapping (SLAM) model.

20. The non-transitory computer-readable storage medium of claim 17, wherein the human mesh tracks movement of the human in the scene.
